(19) United States
(12) Patent Application Publication
(10) Pub. No.: US 2002/0156878 A1
(43) Pub. Date: Oct. 24, 2002

(54) Method and system for monitoring node response time

(76) Inventors: Jeffrey Richard Conrad, Fort Collins, CO (US); Anthony Paul Michael Walker, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/840,242

(22) Filed: Apr. 24, 2001

(51) Int. Cl. G06F 15/173

(52) U.S. Cl. 709/223

(57) ABSTRACT

A method and system is disclosed that transmits a signal from a network manager to each of plural nodes to determine the availability of each node. A response time of each node is determined using the signal. The response time of each node is then relayed to a database of the network manager. Optionally, the response time which is received in a standard format is converted into a flat file format.

### BACKGROUND OF THE INVENTION

1. Field of the Invention

The present invention relates to network management systems, and in particular to network node monitoring.

2. Background Information

The ability to manage networks efficiently is a necessity for institutions of all size. As technology continues to develop and be deployed to an increasing number of users and applications, networks become larger and more complex. Consequently, network management requires monitoring of deployed nodes (i.e, computers, servers, routers, sub-networks, network enabled devices, and the like). The monitoring process includes a variety of parameters that are important to the system manager and the health of the network.

One important parameter that is monitored by network management systems is node availability. It is important for the network managers to know when individual nodes are available or when they are down. It is also desirable to know the response time of individual nodes. Prior systems have obtained the response time of important nodes, such as a file server, by providing systems that individually monitor these important nodes. Typically, the response time is obtained by the using the Internet Control Message Protocol (ICMP) echo request, as specified in RFC792 dated September 1981, which is hereby incorporated by reference. The ICMP echo request will attempt to access the node specified. If the node is successfully accessed, then the ICMP echo reply will report the response time in milliseconds. However, each added ICMP echo request/reply adds to the network traffic (i.e., data transmitted through the network), reducing the available bandwidth for other applications. The system performance would be even further degraded if each node on the network was pinged to determine the response time of all nodes on the network, particularly in networks having of hundreds to thousands of nodes.

Although it is desirable to monitor and track the response time of all the nodes on a network, there is a resulting increase in network traffic. Therefore, it would be desirable to provide a network management system that can monitor the response time of all nodes on the network without significantly increasing network traffic.

### SUMMARY OF THE INVENTION

The present invention is directed to methods and systems that transmit a signal (e.g., Internet Control Message Protocol (ICMP) echo message) from a network manager to each of plural nodes to determine the availability of each node. A response time of each node is determined using the signal. The response time of each node is then relayed to a database of the network manager. Optionally, the response time, which is received in a standard format, is converted into a flat file format. The flat file format can comprise a start time of the response time and a sampling interval, an end time of the sampling interval and a node identification number, wherein the node identification number is an Internet Protocol (IP) address.

### BRIEF DESCRIPTION OF THE DRAWINGS

The above features and advantages of the invention, and additional features and advantages of the invention, will be better appreciated from the following detailed description of the invention made with reference to the drawings, wherein like elements in the drawings will have the same reference number, and wherein:

FIG. 1A shows a flow chart of an exemplary method of the present invention;

FIG. 1B shows a timing diagram of the ICMP messages;

FIG. 2 shows a flow chart of an alternative method of the present invention;

FIG. 3 illustrates a screen shot of an exemplary report generated from the available data; and

FIG. 4 illustrates an exemplary system configuration of the invention.

### DETAILED DESCRIPTION OF THE PREFERRED EMBODIMENTS

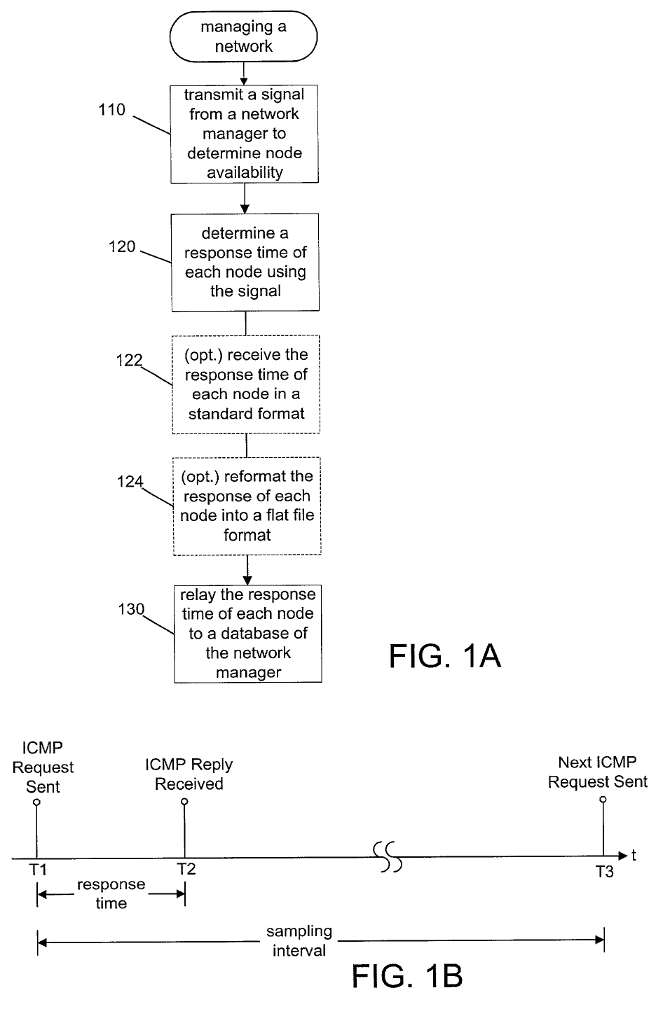

FIG. 1 shows a flow chart of an exemplary method of managing a network such as any wired and/or wireless network having plural nodes configured to communicate in any desired manner over any desired data path. The process starts by transmitting a signal from a network manager to each of plural nodes to determine the availability of each node, in step 110. The network manager refers to a software program that resides on one computer in the system that among other things determines the availability of the various nodes in the network. Typically, this is accomplished via a ICMP echo request signal, however, the invention is not limited to any particular signal format. A response time of each node is determined using the signal, in step 120.

Optionally, the response time of each node is received in a standard format, in step 122. Referring to FIG. 1B a timing diagram of the ICMP messages is shown. The response time is obtained by sampling the system clock when the ICMP echo request is sent over the network (i.e., a start time Ti), and sampling the system clock again when the ICMP echo reply is received (i.e, a reply received time T2). The difference (i.e., T2-T1) is the network response time. An end time T3 is also shown that represents the sampling interval (i.e., the time when the next ICMP echo request is sent). Those skilled in the art will appreciate that the end time can be on the order of minutes, whereas the response time is on the order of milliseconds. The response of each node can be reformatted into a flat file format prior to relaying the response time of each node to the database, in step 124. The flat file format comprises the start time T1 of the response time and sampling interval, the end time T3 of the sampling interval, the response time in milliseconds and a node identification number. The node identification number, can, for example, be an IP address. However, any representation (i.e., numbers, symbols, and/or combinations) that uniquely identifies the node within the network structure can be used.

In step 130, the response time of each node is relayed to a database of the network manager. Typically, the plural nodes comprise substantially all nodes of the network (i.e., all operational nodes in the network). However, the method can be practiced on only a limited set or sets of nodes in the network.

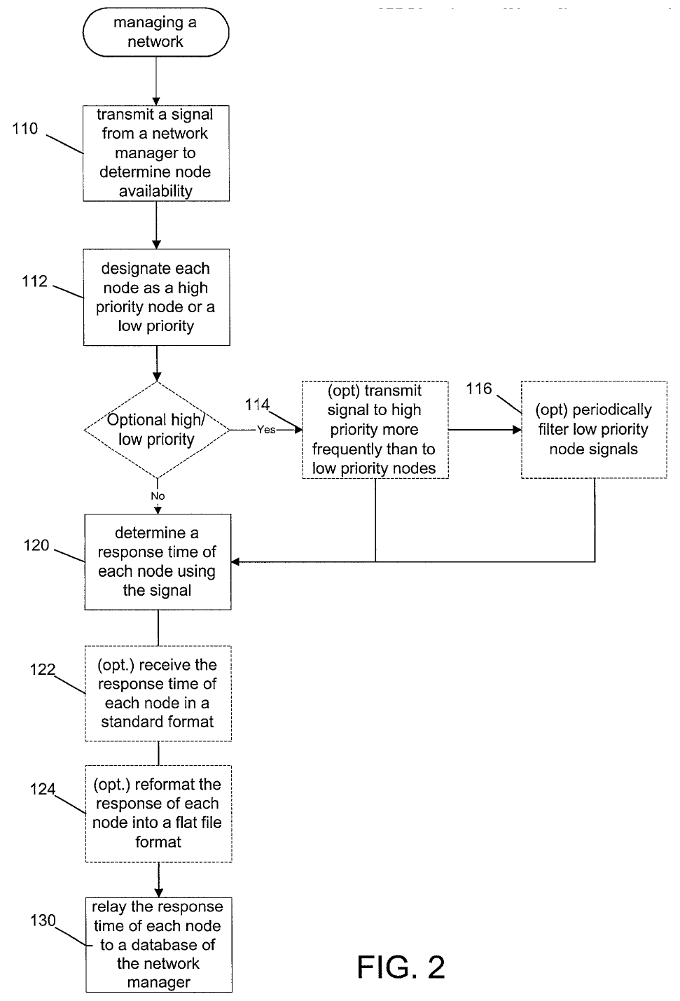

Referring to FIG. 2, another exemplary method of the invention is shown. The process starts as with step 110. However, in the FIG. 2 embodiment, each of the plural nodes are designated as a high priority node or a low priority node, in step 112. Optionally, in step 114, the signal is transmitted to each high priority node more frequently than the signal is transmitted to each low priority node. Alternatively, in step 116, all nodes can be transmitted to at the same interval, however, the responses from the lower priority nodes can be filtered (e.g., a number of signals ignored, averaged, processed to obtain the maximum value, and like) to reduce the number of signals low priority nodes that are relayed to the database. The result of these procedures can advantageously reduce the amount of information relayed to the database, relative to the lower priority nodes. Intermediate designations can also be applied to nodes, such that response time of each node can be determined over a range of intervals, as will be appreciated by those skilled in the art.

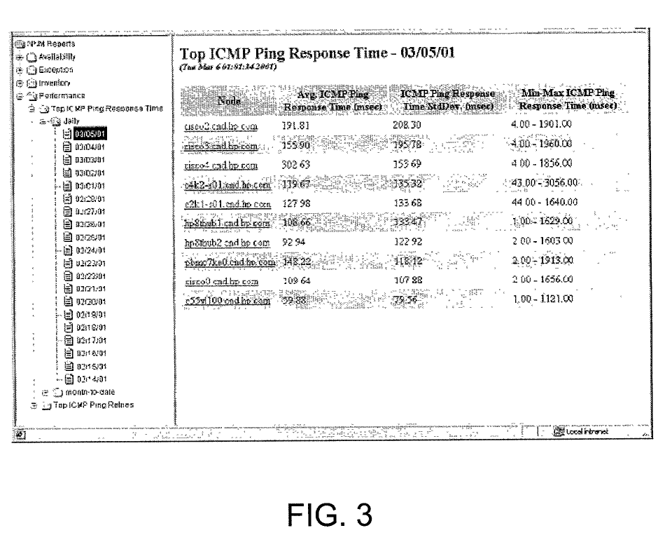

FIG. 3 illustrates a sample screen capture of a report generated from the data relayed to the database. The report was generated by Network Node Manager™ (NNM), which is available from Hewlett Packard and which is an exemplary network manager that can be used in accordance with the present invention. The left side frame shows a hierarchical view of the ICMP ping response times of the past daily slowest response time reports. Two folders, daily and month-to-date, are shown below the Top ICMP Ping Response Times folder. A number of individual folders are below the daily folder containing information obtained for each date.

The right side frame shows the information contained in the Mar. 05, 2001 folder. Specifically, the node names and corresponding ping response statistics (e.g., average, standard deviation, and minimum to maximum range) obtained from the database are displayed.

In addition to the basic availability testing of nodes, the NNM incorporates advanced diagnostics and statistical capabilities. The invention coupled with an advanced network manager, such as NNM, allows for the maximum benefit to be obtained from the node response times obtained. This information can be used to alert network managers of potential node problems, such as network bottlenecks. Additionally, conventional statistical process control techniques can be employed to establish normal operating ranges for each node. Then, statistical deviations from these norms can be flagged to alert the network managers of potential problems. These benefits can be obtained without additional burden to the network traffic.

To facilitate an understanding of the invention, many aspects of the invention are described in terms of sequences of actions to be performed by elements of a computer-based system. It will be recognized that in each of the embodiments, the various actions can be performed by specialized circuits (e.g., discrete logic gates interconnected to perform a specialized function), by program instructions being executed by one or more processors, or by a combination of both. Moreover, the invention can additionally be considered to be embodied entirely within any form of a computer readable storage medium having stored therein an appropriate set of computer instructions that would cause a processor to carry out the techniques described herein. Thus, the various aspects of the invention can be embodied in many different forms, and all such forms are contemplated to be within the scope of the invention. For each of the various aspects of the invention, any such form of an embodiment is referred to herein as “logic that” performs a described action.

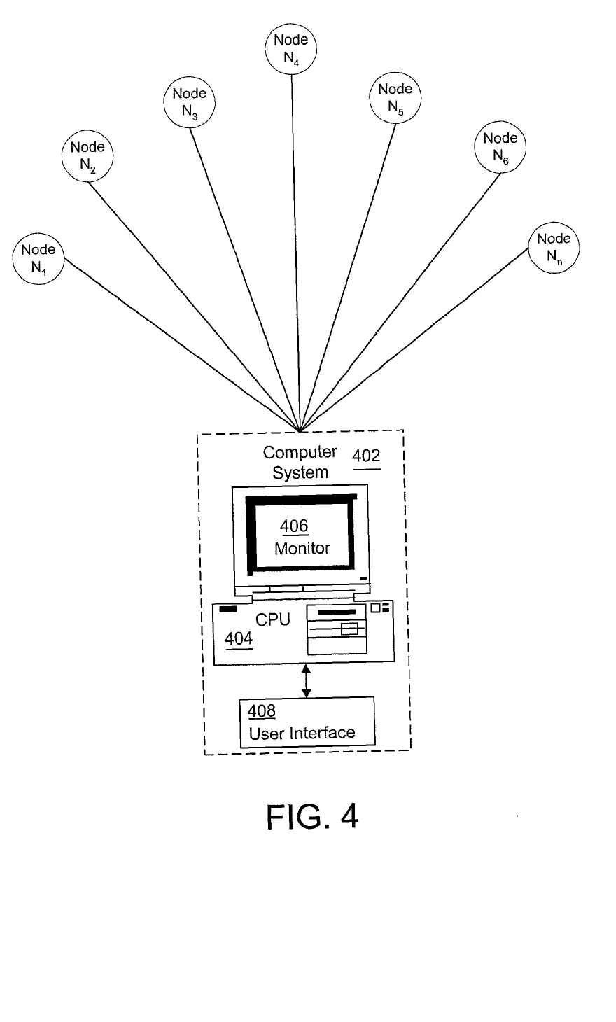

FIG. 4 illustrates an exemplary computer-based system 402 for managing a network. Note, logical operations are not shown in FIG. 4. The computer-based system 402 includes logic that transmits a signal from a network manager (not shown) to each of plural nodes N₁-Nₙ to determine the availability of each node N₁-Nₙ, logic that determines a response time of each node N₁-Nₙ using the signal, and logic that relays the response time of each node N₁-Nₙ to a database of the network manager. The database typically resides on an internal storage device of the computer-based system 402. However, those skilled in the art will appreciate that the database may reside on a remote storage device. Further, the computer-based system 402 can include logic that receives the response time of each node N₁-Nₙ in, for example, a standard format (e.g., a response to an ICMP echo request) or any desired format, and logic that reformats the response time of each node into a flat file format prior to relaying the response time of each node N₁-Nₙ to the database. The computer-based system 402 can comprise logic that designates either autonomously or in response to user inputs, each of the plural nodes N₁-Nₙ as a high priority node or a low priority node and logic that transmits the signal to each high priority node more frequently than the signal is transmitted to each low priority node.

The computer-based system 402 comprises a monitor 406, a processing unit 404, a user interface 408 and a network interface device integrated into computer-based system 402. However, one skilled in the art will appreciate that the network interface device can be separate from the computer-based system 402. Examples of suitable computer-based systems include, but are not limited to, Hewlett Packard 9000 servers and workstations, SunSPARC, Ultra Servers and Workstations, and Intel based personal computers. However, those skilled in the art with appreciate that any computer-based system that can connect to a network is suitable to practice the invention.

The foregoing has described principles, preferred embodiments and modes of operation of the invention. However, the invention is not limited to the particular embodiments discussed above. Therefore, the above-described embodiments should be regarded as illustrative rather than restrictive, and it should be appreciated that variations may be made in those embodiments by those skilled in the art, without departing from the scope of the invention as defined by the following claims.

What is claimed is:

1. A method of managing a network comprising:
transmitting a signal from a network manager to each of plural nodes to determine the availability of each node;
determining a response time of each node using the signal; and
relaying the response time of each node to a database of the network manager.

2. The method of claim 1, further comprising:
receiving the response time of each node in a standard format; and
reformatting the response time of each node into a flat file format prior to relaying the response time of each node to the database.

3. The method of claim 2, wherein the flat file format comprises:
a start time of the response time and a sampling interval;
an end time of the sampling interval;
the response time in milliseconds; and
a node identification number

4. The method of claim 3, wherein the node identification number is an IP address.

5. The method of claim 1, wherein the signal is an Internet Control Message Protocol (ICMP) echo request and an ICMP echo reply.

6. The method of claim 1, wherein the plural nodes comprise substantially all nodes of the network.

7. The method of claim 1, further comprising:
designating at least one of the plural nodes as one of a high priority node and a low priority node; and
transmitting the signal to each high priority node more frequently than the signal is transmitted to each low priority node.

8. The method of claim 1, wherein the network manager is a Network Node Manager.

9. A computer-based system for managing a network comprising:
logic that transmits a signal from a network manager to each of plural nodes to determine the availability of each node;
logic that determines a response time of each node using the signal; and
logic that relays the response time of each node to a database of the network manager.

10. The computer-based system of claim 9, further comprising:
logic that receives the response time of each node in a standard format; and
logic that reformats the response time of each node into a flat file format prior to relaying the response time of each node to the database.

11. The computer-based system of claim 10, wherein the flat file format comprises:
a start time of the response time and a sampling interval;
an end time of the sampling interval;
the response time in milliseconds; and
a node identification number

12. The computer-based system of claim 11, wherein the node identification number is an IP address.

13. The computer-based system of claim 9, wherein the signal is an Internet Control Message Protocol (ICMP) echo request and an ICMP echo reply.

14. The computer-based system of claim 9, wherein the plural nodes comprise substantially all nodes of the network.

15. The computer-based system of claim 9, further comprising:
logic that designates at least one of the plural nodes as one of a high priority node and a low priority node; and
logic that transmits the signal to each high priority node more frequently than the signal is transmitted to each low priority node.

16. The computer-based system of claim 9, wherein the network manager is a Network Node Manager.
